(19) United States
(12) Patent Application Publication
(10) Pub. No.: US 2007/0103514 A1
(43) Pub. Date: May 10, 2007

(54) Heater and inkjet printhead having the same

(75) Inventors: Myong-jong Kwon, Suwon-si (KR); Sung-joon Park, Suwon-si (KR); Yong-shik Park, Seongnam-si (KR); Young-ung Ha, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/488,074

(22) Filed: Jul. 18, 2006

(30) Foreign Application Priority Data
Nov. 4, 2005 (KR) 2005-105476

(51) Int. Cl. B41J 2/05

(52) U.S. Cl. 347/56

(57) ABSTRACT

In a heater and an inkjet printhead having the same, the heater directly contacts and heats ink and is made of a Pt—Ir alloy.

### CROSS-REFERENCE TO RELATED APPLICATIONS

This application claims the benefit of Korean Patent Application No. 10-2005-0105476, filed on Nov. 4, 2005, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to a thermal inkjet printhead having a heater which operates with low electric power and has an extended lifespan.

2. Description of the Related Art

An inkjet printhead ejects minute ink droplets on desired positions of recording paper in order to print predetermined color images. Inkjet printers are classified into two categories: a shuttle type inkjet printer, whose printhead is shuttled in a direction perpendicular to a transporting direction of a print medium, and a line printing type inkjet printer having a page-wide array printhead corresponding to a width of the print medium. The latter has been developed for realizing high-speed printing. The array printhead has a plurality of inkjet printheads arranged in a predetermined configuration. In the line printing type inkjet printer, during printing, the array printhead is fixed and the print medium is transported, thereby enabling the high-speed printing.

The inkjet printhead is categorized into two types according to the ink droplet ejection mechanism thereof. The first one is a thermal inkjet printhead that ejects ink droplets using an expansion force of ink bubbles generated by thermal energy. The other one is a piezoelectric inkjet printhead that ejects ink droplets using a pressure applied to ink due to the deformation of a piezoelectric body.

The ink droplet ejection mechanism of the thermal inkjet printhead is as follows. When a current flows through a heater made of a heating resistor, the heater is heated and ink near the heater in an ink chamber is instantaneously heated up to about 300° C. Accordingly, ink bubbles are generated by ink evaporation, and the generated bubbles expand, thereby exerting a pressure on the ink filled in the ink chamber. Thereafter, an ink droplet is ejected through a nozzle out of the ink chamber.

According to a relationship between a direction of growing an ink bubble and a direction of ejecting an ink droplet, the thermal inkjet printheads are classified into a top-shooting type inkjet printhead, a side-shooting type inkjet printhead, and a back-shooting type inkjet printhead. In the top-shooting type inkjet printhead, the growing direction of the ink bubble and the ejecting direction of the ink droplet are the same. In the side-shooting type inkjet printhead, the growing direction of the ink droplet is perpendicular to the growing direction of an ink bubble. In the back-shooting type inkjet printhead, the ejecting direction of an ink droplet is opposite to the growing direction of the ink bubble.

FIG. 1 is a schematic cross-sectional view illustrating a conventional thermal inkjet printhead. Referring to FIG. 1, the conventional inkjet printhead includes a substrate 11 on which a plurality of material layers are stacked, a chamber layer 20 stacked on the substrate 11 and defining an ink chamber 22, and a nozzle layer 30 stacked on the chamber layer 20. Ink is filled in the ink chamber 22 and a heater 13 heating the ink to generate bubbles therein is installed under the ink chamber 22. In addition, the nozzle layer 30 has a nozzle 32 ejecting the ink.

An insulation layer 12 for heat and electric insulation between the heater 13 and the substrate 11 is formed on the substrate 11. The heater 13 heating the ink in the ink chamber 22 is disposed on the insulation layer 12. The heater 13 can be formed by depositing TaAl, TaN , or HfB₂ on the insulation layer 12 as a thin film and then patterning it. Conductors 14 for supplying an electric current to the heater 13 are disposed on the heater 13. The conductor 14 is made of a conductive material such as aluminum (Al).

A passivation layer 15 is formed on the heater 13 and the conductors 14 so as to protect them. The passivation layer 15 prevents the heater 13 and the conductors 14 from oxidizing or directly contacting the ink, and is mainly made of silicon nitride. An anti-cavitation layer 16 is formed on the passivation layer 15. The anti-cavitation layer 16 protects the heater 13 from a cavitation pressure induced by bubble extinction, and is mainly made of tantalum (Ta).

Recently, since inkjet printheads have been highly integrated to perform high speed printing, low electric power driving is required. In particular, the low electric power driving is essential for array printheads which can ensure high speed printing. The low electric power driving requires a heater having high efficiency. In the above-described conventional thermal inkjet printhead, in order to protect the heater 13, the passivation layer 15 made of silicon nitride (SiNₓ) having low thermal conductivity is formed on an upper side of the heater 13 and the anti-cavitation layer 16 is formed on the passivation layer 15. However, the passivation layer 15 and the anti-cavitation layer 16 limit the high efficiency of the heater 13. In addition, the array printhead realizing the high speed printing requires ten thousands of heaters. If the heaters used in the above-described conventional thermal inkjet printhead are employed for the array printhead, a large amount of electric power is consumed to drive the heaters and a large amount of heat generated by the heaters is accumulated in the array printhead, thereby degrading printing performance and printing quality.

Accordingly, to enhance the efficiency of the heater 13, the passivation layer 15 and the anti-cavitation layer 16 formed on the heater 13 need to be removed. However, if the heater 13 is made of TaAl, TaN, or HfB₂ and directly contacts ink, the heater 13 may corrode. When the heater 13 reacts with moisture in the ink and is thereby oxidized, the resistance of the heater 13 may drastically change and the heater 13 may be damaged by a cavitation pressure generated during bubble extinction. Therefore, a heater made of a material having electrical, chemical, and mechanical durability is highly demanded.

### SUMMARY OF THE INVENTION

The present general inventive concept provides a thermal inkjet printhead having a heater which operates with a low electric power and has an extended lifespan.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a heater usable in an inkjet printhead, the heater directly contacting ink to heat the ink and being made of a Pt—Ir alloy.

A percentage of iridium in the heater may be 20 to 60 at %. The thickness of the heater may be 500 to 2500 Å.

A heating region in the heater may have a size of 200 to 500 μm². Input energy supplied to the heater may be 1.0 μJ or less.

The foregoing and/or other aspects of the present general inventive concept may also be achieved by providing an inkjet printhead including a substrate, a heater formed on the substrate, a conductor which is formed on the heater and supplies a current to the heater, a chamber layer which is stacked on an upper portion of the substrate having the heater and the conductor to form an ink chamber to be filled with ink to be ejected, and a nozzle layer stacked on the chamber layer and having a nozzle through which the ink is ejected, wherein the heater is made of a Pt—Ir alloy.

A heating portion of the heater may directly contact the ink filled in the ink chamber.

A passivation layer may be formed between the substrate and the chamber layer to cover the conductor. The passivation layer may be made of SiNₓ.

An insulation layer for heat and electric insulation between the substrate and the heater may be formed on the upper surface of the substrate. The insulation layer may be made of SiO₂.

The foregoing and/or other aspects of the present general inventive concept may also be achieved by providing a printhead usable in an image forming apparatus, the printhead including a substrate, a chamber layer formed on the substrate, a nozzle layer formed on the chamber layer having a nozzle, and a heater formed on the substrate to form an ink chamber with the chamber layer and the nozzle layer, and directly exposed to the ink chamber to contain the ink to be ejected through the nozzle of the nozzle layer.

The foregoing and/or other aspects of the present general inventive concept may also be achieved by providing a printhead usable in an image forming apparatus, the printhead including a substrate, an insulation layer formed on the substrate, a heater formed on a first portion of the insulation layer and made of at least one of platinum and iridium, a conductor formed on a first portion of the heater, a passivation layer formed on the conductor and a second portion of the heater, a chamber layer formed on a portion of the passivation layer, and a nozzle layer formed on the chamber layer having a nozzle.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view illustrating a conventional thermal inkjet printhead;

FIG. 2 is a schematic cross-sectional view illustrating a thermal inkjet printhead according to an embodiment of the present general inventive concept;

FIG. 3 is a cross-sectional view taken along line III-III′ of FIG. 2;

FIG. 4 is a graph illustrating resistivity of a heater made of a Pt—Ir alloy with respect to an atomic percentage of iridium in a Pt—Ir alloy; and

FIG. 5 is a graph illustrating temperature coefficient of resistance (TCR) of a heater made of a Pt—Ir alloy with respect to an atomic percentage of iridium in a Pt—Ir alloy.

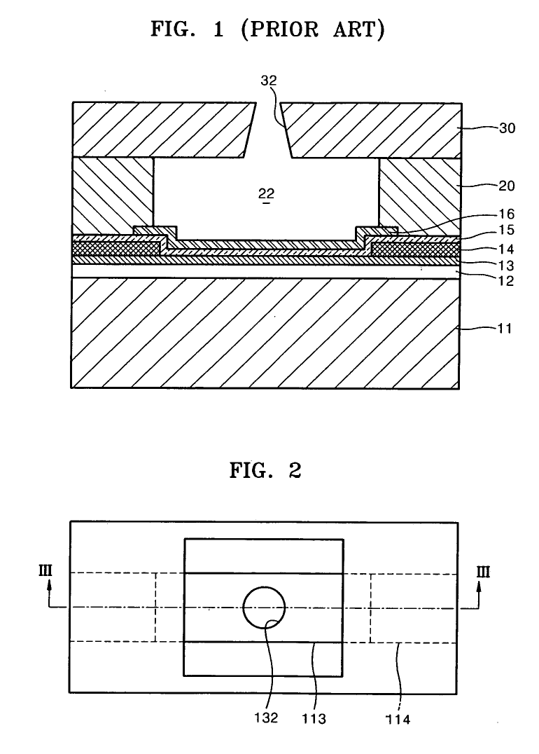

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

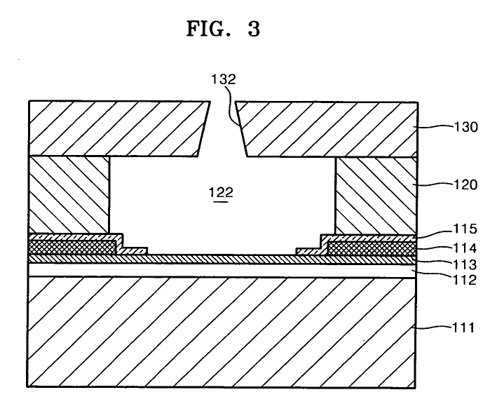

FIG. 2 is a schematic cross-sectional view illustrating a thermal inkjet printhead usable in an image forming apparatus according to an embodiment of the present general inventive concept. FIG. 3 is a cross-sectional view taken along line III-III′ of FIG. 2. Although FIGS. 2 and 3 illustrate a single thermal inkjet printhead, the present general inventive concept is not limited thereto. The image forming apparatus may have one or more thermal inkjet printheads formed on a printhead unit, and each of the one or more thermal inkjet printheads includes one or more inkjet nozzles and one or more heaters.

Referring to FIGS. 2 and 3, the inkjet printhead includes a substrate 111 where a heater 113 and a conductor 114 are formed, a chamber layer 120 which is stacked on the substrate 111 and has an ink chamber 122, and a nozzle layer 130 which is stacked on the chamber layer 120 and has a nozzle 132. The substrate 111 is a silicon substrate, but the present general inventive concept is not limited thereto.

An insulation layer 112 is formed on an upper side of the substrate 111 for heat and electric insulation between the substrate 111 and the heater 113. The insulation layer 112 is made of silicon oxide (SiO₂), but the present general inventive concept is not limited thereto.

The heater 113 having a predetermined shape and heating ink filled in the ink chamber 122 to generate bubbles is formed on the insulation layer 112. In the present embodiment, a heating portion of the heater 113 directly contacts ink filled in the ink chamber 122. The ink chamber 122 is defined by side surfaces of the chamber layer 120, a lower surface of the nozzle layer 130, and an upper surface of the heater 113. The heater 113 is made of a Pt—Ir alloy. The heater 113 is formed by depositing the Pt—Ir alloy as a thin film on the insulation layer 112 using sputtering, and then, patterning the deposited Pt—Ir alloy to have a predetermined shape. The heater 113 may have a thickness of about 500 to 2500 Å. In the present embodiment, input energy applied to the heater 113 through the conductor 114, which will be described later, may be about 1.0 μJ or less.

The conductor 114 is electrically connected between a power source and the heater 113 to supply a current to the heater and is formed on both ends of a top side of the heater 113. The conductor 114 may be made of a metal having electric conductivity, for example, aluminum (Al). The conductor 114 is formed on the heater 113 such that the heating portion of the heater 113, that is, a portion of the heater 113 is exposed to the ink chamber 122 between the conductors 114 and has an area of about 200 to 500 μm². A passivation layer 115 may be formed on the substrate 111 to cover the conductor 114 in order to protect the conductor 114 from the ink. The passivation layer 115 is made of silicon nitride (SiNₓ), but the present general inventive concept is not limited thereto.

The chamber layer 120 having the ink chamber 122 is stacked on a structure of layers, such as the heater 113, the conductor 114, and the passivation layer 115 which are formed on the substrate 111. The chamber layer 120 is made of a polymer, but the present general inventive concept is not limited thereto. The ink chamber 122 is disposed on a heating portion of the heater 113. Accordingly, the heating portion of the heater 113 is disposed on a bottom of the ink chamber 122 to directly contact ink filled in the ink chamber 122. The nozzle layer 130 having the nozzle 132 ejecting the ink filled in the ink chamber 122 is stacked on the chamber layer 120. The nozzle layer 130 is made of a polymer, but the present general inventive concept is not limited thereto. The nozzle 132 may be disposed at a center of the ink chamber 122.

As described above, the inkjet printhead according to the embodiment of the present general inventive concept has a structure in which the heating portion of the heater 113 directly contacts the ink filled the ink chamber 122. When the heater 113 directly contacts the ink, a material to be used for the heater 113 is required to have electrical, chemical, and mechanical durability with respect to ink. Specifically, the heater 113 does not undergo a rapid resistance change by oxidation, corrosion by ink, and a damage by cavitation pressure generated during bubble extinction. Accordingly, the heater 113 is made of the Pt—Ir alloy having an excellent electrical, chemical, and mechanical durability with respect to the ink.

In the above-described embodiment, the heater 113 made of the Pt—Ir alloy is employed in a top-shooting type inkjet printhead, but the present general inventive concept is not limited thereto. For example, the heater 113 can be employed in a side-shooting or back-shooting type inkjet printhead.

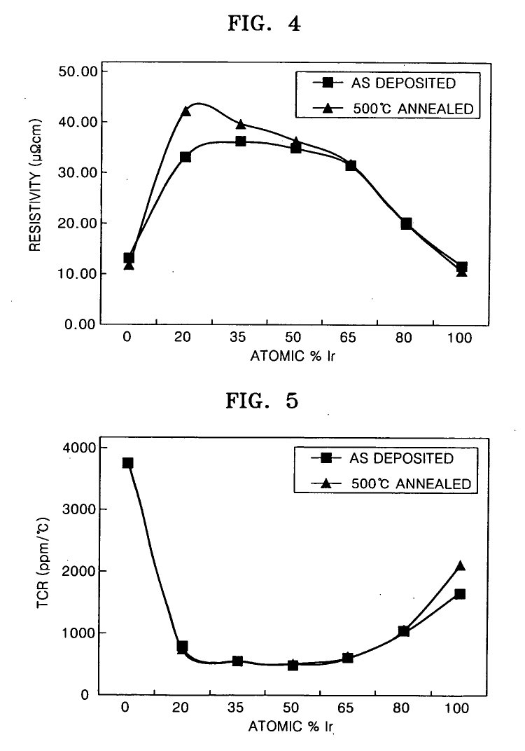

FIG. 4 is a graph illustrating resistivity of a heater made of a Pt—Ir alloy with respect to an atomic percentage of iridium in the alloy. FIG. 4 shows the resistivity of a heater deposited on an insulation layer and the resistivity of a heater annealed at 500° C. after the deposition. The heaters of the inkjet printhead should have high resistivity. Referring to FIG. 4, when the atomic percentage of iridium is in the range from about 20 to 65 at %, the heater has high and approximately constant resistivity.

FIG. 5 is a graph illustrating temperature coefficient of resistance (TCR) of a heater made of a Pt—Ir alloy with respect to an atomic percentage of iridium in the alloy. FIG. 5 illustrates the TCR of the heater deposited on an insulation layer and the TCR of the heater annealed at 500° C. after the deposition. The heaters of the inkjet printhead should have low TCR. Referring to FIG. 5, when the atomic percentage of iridium is in a range from about 20 to 65 at %, the heater has low and approximately constant resistivity. Accordingly, in the inkjet printhead according to the present embodiment, the heater may be made of a Pt—Ir alloy, and the atomic percentage of iridium of the Pt—Ir alloy may be about 20-65 at %.

Based on the above-described results, a heater made of a Pt—Ir alloy having 50% of Pt was selected to evaluate the electrical, chemical, and mechanical characteristics thereof.

First, the heater was disposed in ink at 60° C. for eight weeks, and the shape of the heater was observed. During this period, the heater did not react with the ink and the delamination of the heater did not occur.

After depositing the heater, the resistivity of the heater may change due to subsequent processes. Specifically, when forming a conductor made of aluminum after depositing the heater, the heater may be exposed to an enchant during etching the aluminum. In addition, when patterning the heater, the heater may be exposed to oxygen plasma when removing a photoresist. Thus, a sheet resistance of the heater was measured at each time when a process was finished. The sheet resistance of the heater after depositing the heater was 3.74 Ω/□, the sheet resistance of the heater after aluminum etching was 3.78 Ω/□, and the sheet resistance of the heater after removing the photoresist was 3.75 Ω/□. Accordingly, the resistance of the heater made of the Pt—Ir alloy does not significantly change in the subsequent processes.

In general, a heater should have an electrical strength of about 1.5 GW/m² to form a bubble. In the inkjet printhead according to an embodiment of the present general inventive concept, when a size of a heating portion of the heater made of the Pt—Ir alloy was 22 μm×29 μm, the electrical strength of the heater in air atmosphere was about 3.28 GW/m². Accordingly, the heater made of the Pt—Ir alloy has excellent electric characteristics.

In the inkjet printhead according to the embodiment of the present invention, since the heater directly contacts the ink, the heater should have mechanical durability against cavitation pressure generated during bubble extinction and not have electrochemical reactivity with the ink. Using a commercially available ink, a bubble test of a heater made of a Pt—Ir alloy and having a 22 μm×29 μm heating portion was performed. The energy applied to the heater to form a stable bubble was about 0.75 μJ. This energy is lower than an energy (1.2 μJ) applied to a conventional heater made of TaN and having a 22 μm×29 μm heating portion when a silicon nitride passivation layer of 6000 Å and an anti-cavitation layer of 3000 Å are formed on the conventional heater. When such an input energy was applied to a heater made of a Pt—Ir alloy, the heater had a lifespan of about more than one hundred million pulses. This lifespan indicates that the heater made of the Pt—Ir alloy has good electrical, chemical, and mechanical durability.

As described above, the heater according to the embodiment of the present general inventive concept is made of the Pt—Ir alloy such that the heater has high electrical, chemical, and mechanical durability with respect to ink. Since the heater directly contacts and heats ink, the heater has high efficiency and thereby ensures low electric power driving of an inkjet printhead, in particular, an array printhead. In addition the driving voltage of the inkjet printhead decreases, thereby making it possible to highly integrate nozzles in a nozzle unit. Since a passivation layer on an upper side of the heater is not necessary, a manufacturing process of the inkjet printhead according to the present embodiment is simple.

The general inventive concept may, however, be embodied in many different forms and should not be construed as being limited to the embodiments set forth herein; rather, these embodiments are provided so that this disclosure will be thorough and complete, and will fully convey the concept of the invention to those skilled in the art. For example, it will also be understood that when a layer is referred to as being “on” another layer or a substrate, it can be directly on the other layer or the substrate, or intervening layers may also be present.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A heater usable in an inkjet printhead, the heater directly contacting ink to heat the ink, and being made of a Pt—Ir alloy.

2. The heater of claim 1, wherein a percentage of iridium in the heater is 20 to 60 at %.

3. The heater of claim 1, wherein a thickness of the heater is 500 to 2500 Å.

4. The heater of claim 1, wherein a heating region in the heater has an area of 200 to 500 μm².

5. The heater of claim 4, wherein an input energy supplied to the heater is 1.0 μJ or less.

6. An inkjet printhead comprising:
a substrate;
a heater formed on the substrate and made of a Pt—Ir alloy;
a conductor which is formed on the heater and supplies a current to the heater;
a chamber layer which is stacked on an upper portion of the substrate, and has an ink chamber filled with ink to be ejected; and
a nozzle layer stacked on the chamber layer to form an ink chamber, and having a nozzle through which the ink is ejected.

7. The inkjet printhead of claim 6, wherein a heating portion of the heater directly contacts the ink filled in the ink chamber.

8. The inkjet printhead of claim 7, wherein a percentage of iridium in the heater is 20 to 60 at %.

9. The inkjet printhead of claim 7, wherein a thickness of the heater is 500 to 2500 Å.

10. The inkjet printhead of claim 7, wherein a heating region in the heater has an area of 200 to 500 μm².

11. The inkjet printhead of claim 10, wherein an input energy supplied to the heater is 1.0 μJ or less.

12. The inkjet printhead of claim 7, wherein a passivation layer is formed between the substrate and the chamber layer to cover the conductor.

13. The inkjet printhead of claim 12, wherein the passivation layer is made of SiNₓ.

14. The inkjet printhead of claim 7, wherein an insulation layer for heat and electric insulation between the substrate and the heater is formed on an upper surface of the substrate.

15. The inkjet printhead of claim 14, wherein the insulation layer is made of SiO₂.
